(19) United States
(12) Patent Application Publication
(10) Pub. No.: US 2010/0225548 A1
(43) Pub. Date: Sep. 9, 2010

(54) FLAT ANTENNA WITH AT LEAST TWO EMITTER SECTIONS FOR SENDING AND RECEIVING HIGH FREQUENCY SIGNALS

(76) Inventors: Markus PFLETSCHINGER, Eningen (DE); Bernd SCHWARZ, Walddorf-Haeslach (DE)

Correspondence Address: KF ROSS PC, 5683 RIVERDALE AVENUE, SUITE 203 BOX 900, BRONX, NY, 10471-0900, US

(21) Appl. No.: 12/628,389

(22) Filed: Dec. 1, 2009

(30) Foreign Application Priority Data
Mar. 6, 2009 (DE) 102009011494.7

(51) Int. Cl. H01Q 1/32; H01Q 1/48; H01Q 1/36

(52) U.S. Cl. 343/713; 343/846; 343/893

(57) ABSTRACT

An antenna has a flat support and two separate and flat emitter sections for transmitting or receiving high-frequency signals flatly fixed to the support. One of the emitter sections is flat and areal and the other of the emitter sections is a meander. A coil is fixed flatly on the support and connected to both of the emitter sections, and a ground terminal is also fixed flatly on the support.

### FIELD OF THE INVENTION

The present invention relates to an antenna. More particularly this invention concerns such an antenna having two emitter sections for sending and/or receiving high-frequency signals.

### BACKGROUND OF THE INVENTION

A rod antenna, known as a so-called Lambda quarter rod, has at least two emitter sections for transmitting and/or sending high-frequency signals and a ground connection. Such an antenna is frequently mounted on a vehicle, such as for citizen-band (CB) radio. A special application of rod antennas is known for trucks in the US, where such rod antennas are mounted on the roof of the cab. The arrangement is difficult to access such that a required tuning of the antenna, requiring a fixed and a variable emitter section, can be carried out only at considerable expense and effort.

Furthermore, such antennas are a detriment to the overall appearance and aerodynamics of a vehicle, particularly of the truck, where they are also limited in efficiency. The greatest main disadvantage is that long antenna rods are permissible on truck roofs in Europe only, if the permitted overall height of 4 m is not exceeded. However, in most cases the driver's cab is already nearly 4 m high such that the antenna rod may not be mounted on the roof. Installation of the antenna rods parallel to the metal cabin rear wall, or the cabin front, is often the only alternative, but may be of disadvantage for the performance of the antenna from the antenna's technical point of view due to the shielding effects. Poor radiation and impedance detuning are the result.

### OBJECTS OF THE INVENTION

It is therefore an object of the present invention to provide an improved high-frequency antenna.

Another object is the provision of such an improved high-frequency antenna that overcomes the above-given disadvantages, in particular that has good performance while being easy to install, in particular in a vehicle, and inexpensive to manufacture.

### SUMMARY OF THE INVENTION

An antenna has according to the invention a flat support and two separate and flat emitter sections for transmitting or receiving high-frequency signals flatly fixed to the support. One of the emitter sections is areal and the other of the emitter sections is a meander. A coil is fixed flatly on the support and connected to both of the emitter sections, and a ground terminal is also fixed flatly on the support.

The overall flat shape of the antenna has the advantage that it may be integrated in or on the vehicle at any desired installation location such that the outward appearance of the vehicle is no longer influenced by the presence of the flat antenna according to the invention. Due to the combination of the flat areal and the meandering emitter sections the installation height or length of the flat antenna is significantly reduced as opposed to a comparable rod antenna such that only a reduced installation height is required for the flat antenna. Due to the flat embodiment of the antenna the broadband capacity of the antenna according to the invention is significantly increased as opposed to rod-shaped, tunable antennas. Hence, tuning of the antenna is not necessary for operation.

Making the first emitter section flat or areal, that is as an imperforate or continuous surface, has the advantage that the performance of the antenna according to the invention is significantly increased such that particularly during operation of the antenna in connection with high-capacity boosters any damage to the antenna, particularly by the effect of heat, if effectively prevented. In this regard significant performance increases of the antenna result in improved reception or greater range are possible. The meander of the second emitter section has the further advantage that in this manner the installation height, or also the length of the antenna is significantly increased with the simultaneous increase of performance and omitting the tuning normally required by broadband capacity.

According to a further feature of the invention one of the two emitter sections, preferably both emitter sections, are formed by an electrically conducting material that is printed like a printed-circuit trace on the support. The printing of the electrically conducting material onto the support has the advantage that the desired structures (flat or meandering) can be realized in a simple manner by screen printing, for instance. Furthermore, such a printing method may be carried out very quickly and rationally such that production expense is significantly reduced. In addition to the application of electrically conducting materials, such as pastes, preferably silver polymer pastes, other application methods (such as spraying on) are also conceivable to make the desired flat emitter sections. For this purpose it is critical that the material of the support and the electrically conducting material to be applied at that location are adjusted to each such that the electrically conducting material applied bonds to the face if the support with sufficient strength and permanency such that peeling off is prevented during the life of the antenna.

In a further improvement of the invention the coil electrically connecting the two emitter sections to each other is also formed from the electrically conducting material printed on the support. This can be done the same way as the emitter sections.

### BRIEF DESCRIPTION OF THE DRAWING

The above and other objects, features, and advantages will become more readily apparent from the following description, reference being made to the accompanying drawing whose sole figure is a partly schematic elevational view of the antenna according to the invention.

### SPECIFIC DESCRIPTION

As seen in the drawing a flat or flat antenna 1 according to the invention has a flat support 2 that can be rigid or flexible, preferably a rigid or bendable plastic film. Other materials are also conceivable for the support 2, such as an epoxy-resin plate or the like.

A ground connection 3 is provided preferably at a front side or end of the support 2. In this embodiment the ground connection is embodied as an electrically conductive trace printed on the support 2.

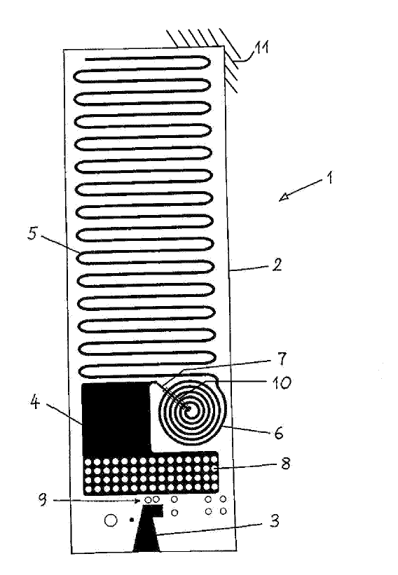

Furthermore, (as viewed in FIG. 1) a first flat emitter section 4 is provided in the lower third of the antenna 1, and a second meandering emitter section 5 is provided in the adjacent larger region of the support 2, occupying about two-thirds of the area of the generally rectangular antenna 1.

The emitter section 5 transitions at one end on the input side into an outer end of a spiral flat coil 6 formed as a flat trace on the support 2 adjacent the flat emitter 4. An electrical connection 7 at the center input end of the spiral coil 6 is connected to the outer end of the other antenna 4. This connection 7 is a conductive lead surrounded where it crosses the coil 6 by an insulating jacket. Ends of the connection 7 are soldered or held in place by an electrically conductive adhesive.

The electrical connection 7 reaches from the center of the coil 6 to the first emitter section 4 over the coil 6, insulated therefrom by a dielectric layer or strip 10, although the conductor trace 7 could be printed directly on the support 2 with the insulating strip 10 on top of it so that the coil 6 can then be printed on top of it without electrical contact. This has the advantage of simple production by printing or the like of the electrically conducting areas of the antenna 1 including the electrical connection 7 and the insulating strip 10. Since the electrical connection 7 reaches across the individual windings of the spiral coil 6, it is necessary to dispose the insulation layer 10 between the turns the coil 6 that are crossed by the electrical connection 7 in order to avoid any short circuits. The insulation layer 10 may also be mounted on the support 2 and the already attached areas of the coil 6 in advantageous manner, the electrically conducting material being applied or reprinted for realizing the electrical connection 7 only after the original process of printing the coil.

The electrical connection 7 reaches from the tapered end of the emitter section 4 to the center input of the coil 6, while the outer end of the coil 6 transitions directly into the meandering emitter section 5. At this point it should be mentioned that it may also be conceivable as a functionally equal alternative that the outer input of the coil 6 is connected to the emitter section 4, also particularly at the tapered end thereof, whereas the inner end of the coil is connected to the one end (input) of the meandering emitter section 5 via the electrical connection 7.

To minimize material use the flat emitter section 4 may have one or multiple cutouts 8 that have any desired shape without modifying or limited the performance or broadband capacity. The shape and number of cutouts 8 shown in the drawing are shown by way of example only, and may be varied. It is also understood and conceivable that the emitter section 4 is made in a completely flat solid manner, that is without any cutouts.

Furthermore, the antenna 1 has connections 9 between the one front end of the emitter section 4 and the rear end of the ground contact 3 so that a high-frequency cable, particularly a coaxial cable, can be connected at that location. The core of this high-frequency cable is thus connected to the emitter section 4, and the ground conductor of the high-frequency cable (such as a shielding mesh) is connected to the ground terminal 3. This may be done, for example, by soldering, crimping, gluing using an electrically conducting adhesive, laser or ultrasonic welding, or the like. In order to protect the exposed end of the high-frequency cable that is connected to the emitter section 4 and the ground 3 from adverse exterior influences (particularly from dirt particles and moisture, which could lead to an adverse effect of the antenna's function) the area may be provided with a cover. The cover may be, for example, a housing part comprised of a plastic material and may be embodied in a manner reaching across the connections 9 toward the emitter section 4 and the ground terminal 3. In a particularly preferred manner the connections 9 are protected from exterior influences by a plastic material in an injection molding process, preferably a hot-melt process. To this end the high-frequency cable may additionally be fixed on the support 2 of the antenna 1 via further measures for stress relief, particularly a second injection-molding process.

The elongated rectangular shape of the antenna 1 shown in FIG. 1 is of particular advantage, if the flat antenna 1 is integrated into an outside rearview mirror of a truck, here indicated schematically at 11. This means that the shape of the antenna 1 is chosen such that the it fits the installation or space. Installation of such a flat antenna 1 according to the invention into the outside rearview mirror is therefore of particular advantage because the antenna is non visible from the exterior after installation and wiring thereof, thus no longer having an adverse effect on the overall appearance of the vehicle. Furthermore, the shapes of the ground terminal 3, of the flat emitter section 4, and of the meandering emitter section 5, as well as the width and height of the support 2, may be easily adjusted to the desired frequency band in which the antenna 1 is to transmit and receive, and/or to the installation site, without limiting its simple shape, the broadband capacity, and the performance of the antenna 1.

The first emitter section 4 illustrated in the drawing is L-shaped so the coil 6 can be nested with it to facilitate compactness. However, this does not mean that other geometric shapes of the emitter section 4, such as round, square, rectangular, arcuate, or the like are excluded. For example, it could be conceived to make the flat emitter section U-shaped having broad legs, and to set the coil 6 between the U-legs with significantly thinner spiral windings as opposed to the broad legs of the U-shaped emitter section 4. This also applies to the shape of the meandering emitter section 5 where the number, length, and radius may be changed. It is therefore not essential that the straight sections of the emitter section 5 extend parallel to each other, but they may also extend, for example, at an angle deviating from parallel.

The embodiment and use of the flat antenna is especially critical and of particular advantage as an antenna for transmitting and receiving high-frequency signals within the frequency range of CB radio. For this purpose the transmitting and receiving of high-frequency signals is carried out in the frequency range of about 27 MHz. A wavelength of 12 m results from the frequency, wherein known rod antennas are embodied as Lambda quarter rods (λ/4 rod) in a commonly known manner, since it is known that with such design good compromises can be achieved in connection with the length of the rod relative to the receiving or transmitting properties. However, at this frequency band the antenna length must be about 3 m, thus resulting in problems with the use of the rod antenna in vehicles, since a 3 m-long rod antenna cannot be mounted atop a vehicle, or can only be mounted at great expense. As a result the length must be reduced in the known rod antennas, leading to a significant reduction of broadband capacity, transmitting and receiving performance, and overall performance. Furthermore, rod antennas have the disadvantage that they are very narrow-banded, the known rod antennas having tuning elements in order to be able to tune them.

In contrast the use of the flat antenna according to the invention in 27 MHz frequency range provides the advantages that the installation height is significantly reduced, that an improved heat radiation is provided due to the flat shape (leading to a simultaneous increase of the performance of the antenna), that improved aerodynamics of the vehicles are provided (especially, if the flat antenna is integrated in an outside rearview mirror 11 of a vehicle in an advantageous manner, such as of a truck), and that the flat antenna comprises a significantly increased broadband capacity as opposed to the known rod antennas due to the emitter elements, and that tuning measures may be omitted (due to the higher broadband capacity)

We claim:

1. An antenna comprising:
a flat support;
two separate and flat emitter sections for transmitting or receiving high-frequency signals flatly fixed to the support, one of the emitter sections being areal and the other of the emitter sections being a meander;
a coil fixed flatly on the support and connected to both of the emitter sections; and
a ground terminal fixed flatly on the support.

2. The antenna defined in claim 1 wherein both the emitter sections are conductive traces printed on a face of the support.

3. The antenna defined in claim 2 wherein the coil is a conductive trace printed on the face of the support.

4. The antenna defined in claim 3 wherein the coil is a spiral having an inner and an outer end, the outer end merging unitarily with the meander.

5. The antenna defined in claim 4, further comprising
a conductor extending from the inner end to the flat and areal emitter.

6. The antenna defined in claim 5 wherein the conductor crosses turns of the coil and the antenna further comprises
a dielectric layer between the coil and the conductor.

7. The antenna defined in claim 3 wherein the ground terminal is a trace printed on the face of the support.

8. The antenna defined in claim 3, further comprising
a connector on the one face connected to the flat areal emitter and adapted for connection to a high-frequency cable.

9. The antenna defined in claim 1 wherein the emitter sections are tuned to a 27 MHz range.

10. The antenna defined in claim 1, further comprising
a vehicle outside rearview mirror having a cavity in which the antenna is complementarily fitted and mounted.

11. The antenna defined in claim 1, further comprising
a plastic vehicle body part to which the support is fixed.
